(19) United States
(12) Patent Application Publication
(10) Pub. No.: US 2026/0156397 A1
(43) Pub. Date: Jun. 4, 2026

(54) EARPHONE CONNECTOR AND PREPARATION METHOD THEREOF

(71) Applicant: Luxshare precision accessory (Suzhou) LTD., Suzhou City (CN)

(72) Inventor: Gangqiang LIU, Suzhou City (CN)

(73) Assignee: Luxshare precision accessory (Suzhou) LTD., Suzhou City (CN)

(21) Appl. No.: 19/067,208

(22) Filed: Feb. 28, 2025

(30) Foreign Application Priority Data
Nov. 29, 2024 (CN) 202411747746.9

(51) Int. Cl. H04R 1/10; H01R 13/03; H01R 43/16

(52) U.S. Cl. CPC H04R 1/1025; H01R 13/035; H01R 43/16; H04R 2420/09

(57) ABSTRACT

An earphone connector and a preparation method thereof are provided. The earphone connector includes a first component and a second component combined with each other, the first component is made of a first plastic material of electroplating grade, the second component is made of a second plastic material of non-electroplating grade, a portion of the first component exposed from the second component is covered with a metal electroplating layer, and an inner side of the first component is provided with a blocking wall structure.

### CROSS-REFERENCE TO RELATED APPLICATION

This application claims priority to Chinese Patent Application No. 202411747746.9 filed Nov. 29, 2024, the disclosure of which is incorporated herein by reference in its entirety.

### TECHNICAL FIELD

The present disclosure pertains to the field of earphone manufacturing technology, and relates to an earphone connector and a preparation method thereof.

### BACKGROUND

With the development of science and technology, people have put forward higher requirements for the convenience of carrying and using electronic devices. In this context, the emergence of the true wireless stereo (TWS) meets people's needs for small size, easy to carry and use of earphones. In the related art, the TWS are generally of an integrated structure and are equipped with a charging case adapted thereto. The wireless earphone is placed in the charging case and charged through the earphone connector.

In the prior art, CN211789653U disclosure a wireless earphone charging connector, which includes a pair of charging electrodes, and a first insulator and a second insulator that combine the pair of charging electrodes into one body. Each charging electrode includes an arc-shaped contact portion and a conductive pin extending from a lower end of the arc-shaped contact portion. An isolation gap is formed between the pair of charging electrodes, the first insulator is formed to connect the pair of charging electrodes into one body, and the second insulator closes the isolation gap. The manufacturing method of the wireless earphone charging connector is as follows: first, a pair of charging electrodes are stamped out of a metal sheet, a bridge body that connects the pair of charging electrodes into one body is formed at the top openings of the charging electrodes, then by a first injection molding, the first insulator is formed, and the bridge body is separated from the first insulator, finally the charging electrodes are placed in the injection mold, the second insulator is formed, and the holes to be filled and the avoidance space produced in molding the first insulator are closed by the second insulator.

It can be seen that the overall structure of the earphone charger in the prior art is relatively complex, and the molding process of the earphone charger is cumbersome, the production efficiency is low, and it is not conducive to large-scale industrial production.

In summary, it is an issue to be addressed urgently by the person skilled in the art to provide an earphone connector with simple structure, low cost, simple manufacturing process and high production efficiency and a preparation method thereof.

### SUMMARY

In view of the shortcomings of the prior art, aspects of the present disclosure are to provide an earphone connector and a preparation method thereof, the overall structure of the earphone connector is simple, the obtained product has an excellent quality, the molding is simple, the production efficiency is high and the production cost is low.

In order to achieve these aspects, the following technical schemes are adopted in the present disclosure:

In a first aspect, the present disclosure provides an earphone connector, which includes a first component and a second component that are combined with each other. The first component is made of a first plastic material of electroplating grade, the second component is made of a second plastic material of non-electroplating grade, a portion of the first component exposed from the second component is covered with a metal electroplating layer, and an inner side of the first component is provided with a blocking wall structure.

The earphone connector according to the present disclosure is formed by combining only the first component and the second component into an integral structure, and the metal plating layer is used to cover the portion of the first component exposed from the second component, so that an electrical connection structure can be directly formed on the first component, which is convenient for electrical connection with the earphone charging case to realize charging of the earphone. Thus, the overall structure is simple and the production efficiency can be greatly improved.

It is to be noted that the blocking wall structure is provided on the inner side of the first component according to the present disclosure, which is intended to control the flow behavior of the second plastic material in molding the earphone connector by a double-color injection molding machine, so as to guide the second plastic material to flow along a predetermined path; and if no blocking wall structure is provided, the second plastic material will flow along other paths, and will be mixed with part of the first plastic material to form a different color, and the different color will be produced on an outer surface of the second component, and the different color part will absorb the metal plating material, that is, excess plating will occur, thereby adversely affecting the electrical connection effect between the earphone connector and the earphone charging case. Due to the guiding effect of the blocking wall structure provided in the present disclosure, the producing of different color can be greatly reduced, and the location at which different color may be produced can be changed, so that a trace amount of different color is formed on an inner surface of the second component, the different color produced is greatly reduced, and the ability to absorb metal electroplating materials is no longer available, so that the problem of excess plating will not occur, and the effect of electrical connection between the earphone connector and the earphone charging case is ensured.

In one or more embodiment of the present disclosure, the portion of the first component exposed from the second component has a first protrusion, a second protrusion and a third protrusion protruding from a surface of the second component. The first protrusion is a ground pin, and the second protrusion is a power pin. The third protrusion has a through hole that penetrates inner and outer surfaces of the first component, and the third protrusion is electrically connected to the first protrusion.

In the present disclosure, in molding the first component, the first shot mold is used to directly form the first component having the first protrusion, the second protrusion and the third protrusion with the third protrusion being provided with a through hole, which serve as the ground pin, the power pin and the microphone hole respectively, without the need to use other components to form the above-mentioned functional structures, this further makes the overall structure of the earphone connector of the present disclosure simpler and easier to form, and further improves the production efficiency.

In the present disclosure, by electrically connecting the microphone hole with the ground pin, the reference potential of the audio signal is ensured to be stable, so that the microphone can correctly transmit sound signals.

In one or more embodiment of the present disclosure, there is a beam structure between the third protrusion and the second protrusion, and the blocking wall structure is located on one side of the beam structure and connected to the beam structure.

It is to be noted that, the blocking wall structure is formed on one side of the beam structure and in connection with the beam structure, so that in forming the second component, the second plastic material can flow in the direction guided by the blocking wall structure, and will not directly flow over the beam structure, such that the second plastic material is not divided into two streams until being on the inner side of the bottom of the first component and then the two streams are merged on the inner surface of the second component, and it will not occur that the second plastic material is divided into two streams at the top of the first component and the two streams are merged on the outer surface of the second component, then the second plastic material will fill the cavity of the second injection mold; and if the blocking wall structure is not provided, but the beam structure is passed over directly, the second plastic material will produce a different color with the first component when flowing over the beam structure, and the second plastic material will be divided into two streams by the beam structure, and at the filling end of the second component, the two streams of plastic material will merge, producing more different color, and the different color will be formed on the outer surface of the second component, causing excess plating. The blocking wall structure and its positional relationship with the beam structure provided in the present disclosure solve the problem of excess plating.

In a second aspect, a preparation method of an earphone connector as described in the first aspect is provided according to the present disclosure. The preparation method includes steps as follows.
(1) In first-shot injection molding, a first plastic material of electroplating grade is injected into a first shot mold of a double-color injection molding machine, and after solidification, a first component is obtained.
(2) In second-shot injection molding, a second plastic material of non-electroplating grade is injected into a second shot mold of the double-color injection molding machine at the molding position of the first component, and the second plastic material is combined with the first component along an outer side of the blocking wall structure in a predetermined flow direction, and after solidification, a second component is obtained.

In the preparation method according to the present disclosure, a conventional double-color injection molding machine in the prior art can be used, and the double-color injection molding machine is used to prepare the first component and the second component. The first-shot injection molding and the second-shot injection molding share the same common mold parts, and there is no need to take out the first-shot product from the mold and implant it into the second-shot mold, thereby achieving high-precision and high-efficiency injection molding.

In one or more embodiment of the present disclosure, the melting temperature of the first plastic material ranges from 250 degree Celsius to 280 degree Celsius.

In one or more embodiment of the present disclosure, the melting temperature of the second plastic material ranges from 295 degree Celsius to 315 degree Celsius.

It is to be noted that, if the “standard double-shot injection molding process” is adopted, the temperature of the second shot material is to be controlled at about 60 degree Celsius lower than that of the first shot material, in this way, the second shot material will not melt part of the surface of the first shot material when flowing by the first shot material during the second shot molding. However, if in the present disclosure, the earphone connector is prepared according to the standard double-shot injection molding process, that is, the second component is first formed by using the second injection molding material with a high melting temperature, and then the first component is formed by using the first injection molding material with a low melting temperature to be combined with the second component, when the combination is performed based on the structures of the first component and the second component, ruptures may be caused between the two components due to stress, and the first component cannot be combined with the second component. For injection molding the earphone connector, through adjustment, the second plastic material with a melting temperature higher than that of the first plastic material is taken as the second shot material in the present disclosure. Compared with the standard double-shot injection molding process, the present disclosure takes the opposite approach. In addition, a blocking wall structure is formed on the inner side of the first component in molding the first component, therefore, even if the temperature of the second plastic material is higher than that of the first plastic material, the blocking wall structure changes the flow direction of the second plastic material, and it will not occur that the second plastic material is divided into two streams and then the two streams are merged on the outer surface of the second component. Even if part of the surface of the first component is melted and mixed into the second plastic material due to the interaction between high and low temperatures, the different color producing can be greatly reduced and the location where the different color is produced can be changed due to the role of the blocking wall structure, thereby solving the problem of excess plating.

In one or more embodiment of the present disclosure, in step (2), the injection speed of the second plastic material in the second shot mold ranges from 90 mm/s to 110 mm/s.

It is to be noted that, by controlling the injection speed of the second plastic material in the second shot mold within the range from 90 mm/s to 110 mm/s to ensure that the second plastic material quickly passes along the outer side of the blocking wall structure during the injection molding process, it is conducive to reducing the melting of the surface of the first component and further avoiding the problem of different color producing during the second injection molding. If the injection speed of the second injection is lower than 90 mm/s, the different color producing will increase; and if the injection speed of the second injection is higher than 110 mm/s, the second plastic material cannot fill the cavity of the second injection mold, which may adversely affect the molding effect of the second component.

In one or more embodiment of the present disclosure, the preparation method further includes step (3) in which the portion of the first component exposed from the second component is electroplated.

In the present disclosure, by forming electrical connection pins on part of the protrusions of the first component exposed from the second component by electroplating, in combination with the double-shot injection molding method, the preparation process of the earphone connector is greatly simplified.

In one or more embodiment of the present disclosure, before the electroplating process, the portion of the first component exposed from the second component is roughened.

In the present disclosure, the adhesion between the first component and the first metal layer can be increased by the roughening process, thereby ensuring the electroplating effect.

In one or more embodiment of the present disclosure, the electroplating process includes: electroplating a first metal layer on the portion of the first component exposed from the second component, and electroplating a second metal layer on the first metal layer.

In the present disclosure, the two metal layers are used as the electroplated metal layer, thereby further improving the stability of electrical connection.

Compared with the prior art, the present disclosure can achieve the following beneficial effects:
(1) The earphone connector according to the present disclosure has a blocking wall structure on the inner side of the first component. When double-color injection molding is performed to form the earphone connector, the blocking wall structure controls the flow behavior of the second plastic material to guide the second plastic material to flow along a predetermined path, thus avoiding the second plastic material and the first plastic material from being partially mixed to form a different color on the outer surface of the second component, thereby ensuring that no excess plating will occur on the surface of the second-shot molded plastic part during the electroplating process, thereby ensuring the electrical connection effect between the earphone connector and the earphone charging case.
(2) The earphone connector according to the present disclosure has the blocking wall structure formed on one side of the beam structure and connected to the beam structure, thereby ensuring that in molding the second component, the second plastic material flows along the direction guided by the blocking wall structure, and does not directly flow over the beam structure, such that the second plastic material is not divided into two streams until being on the inner side of the bottom of the first component and then the two streams are merged on the inner surface of the second component, and it will not occur that the second plastic material is divided into two streams at the top of the first component and the two streams are merged on the outer surface of the second component, which further reduces the different color producing and solving the problem of excess plating, thereby improving product performance and reliability.
(3) The earphone connector according to the present disclosure is formed by combining only the first component and the second component into an integral structure, and the metal electroplating layer is used to cover the protruding portion of the first component exposed from the second component, so that an electrical connection structure can be directly formed on the first component, thereby realizing electrical connection with the earphone charging case, without the need to use other components to form the above-mentioned functional structure. The overall structure is simple, and the production efficiency is greatly improved.
(4) The preparation method according to the present disclosure is completely opposite to the temperature selection of injection molding materials in the standard double-shot injection molding process. When the first component and the second component are combined based on the structures thereof in a standard double-shot injection molding process, ruptures may be caused between the two components due to stress, and the first component cannot be combined with the second component. Therefore, by adjusting to take the second plastic material with a higher melting temperature than the first plastic material as the second-shot material, high stress can be avoided between the first component and the second component, ensuring smooth molding of the product.
(5) In the preparation method according to the present disclosure, a double-color injection molding machine is used to prepare the first component and the second component that are combined with each other. There is no need to take out the first-shot product from the mold and implant it into the second-shot mold, in combination with controlling the injection speed of the second plastic material in the mold, high-precision and high-efficiency injection molding is achieved, and the obtained product has excellent quality, the molding is simple and the production efficiency is high.

### BRIEF DESCRIPTION OF DRAWINGS

FIG. 1 is a schematic diagram of the overall structure of an earphone connector according to the present disclosure;

FIG. 2 is a schematic structural diagram of a first component and a second component in the earphone connector according to the present disclosure;

FIG. 3 is a schematic diagram of the flow direction of injecting second injection molding material when molding the second component in a case where a blocking wall structure is not provided according to the present disclosure; and

FIG. 4 is a schematic diagram of the flow direction of injecting second injection molding material when molding the second component in a case where a blocking wall structure is provided according to the present disclosure.

### REFERENCE NUMERALS LIST:

1—earphone connector
2—first component
3—second component
4—first protrusion
5—second protrusion
6—third protrusion
7—through hole
8—beam structure
9—blocking wall structure

### DETAILED DESCRIPTION

The technical schemes of the present disclosure are clearly and completely described hereinafter in conjunction with the drawings. Obviously, the described embodiments are part of the embodiments of the present disclosure, rather than all of the embodiments. Based on the embodiments in the present disclosure, all other embodiments obtained by the person of ordinary skills in the art without making creative efforts are within the scope of protection of the present disclosure.

In the description of the present disclosure, it should be noted that the orientations or position relationships indicated by the terms “center”, “up”, “down”, “left”, “right”, “vertical”, “horizontal”, “inside”, “outside”, etc. are based on the orientations or position relationships shown in the drawings, and are simply for the convenience of describing the present disclosure and simplifying the description, rather than indicating or implying that the device or element referred to must have specific orientations, be constructed and operated in specific orientations, and therefore cannot be understood as limitations of the present disclosure. In addition, the terms “first” and “second” are only used for descriptive purposes and cannot be understood as indicating or implying relative importance. The terms “first position” and “second position” are two different positions, and the first feature “above”, “over”, “on” the second feature include the first feature directly and diagonally above, over, on the second feature, or simply indicate that the first feature is higher in level than the second feature. The first feature “below”, “under”, “beneath” the second feature include the first feature directly and diagonally below, under, beneath the second feature, or simply indicate that the first feature is lower in level than the second feature.

In the description of the present disclosure, it is to be noted that, unless otherwise clearly specified and limited, the terms “installed”, “connected to each other” and “connected” are to be construed in a broad sense, for example, as permanently connected or detachably connected or integrally connected; mechanically connected or electrically connected; directly connected to each other or indirectly connected to each other via an intermediary; or internal communication of two components. For the person of ordinary skills in the art, meanings of the above terms in the present disclosure may be construed according to specific circumstances.

### Earphone Connector

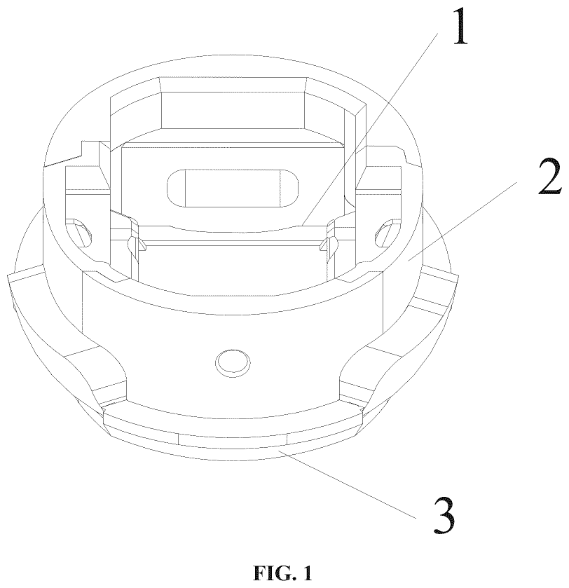

An earphone connector 1 is provided according to an embodiment of the present disclosure, and FIG. 1 is a schematic diagram of the overall structure of the earphone connector. As shown in FIG. 1, the earphone connector 1 includes a first component 2 and a second component 3 that are combined with each other. The first component 2 is made of a first plastic material of electroplating grade, the second component 3 is made of a second plastic material of non-electroplating grade, a portion of the first component 2 exposed from the second component 3 is covered with a metal electroplating layer, and inner side of the first component 2 is provided with a blocking wall structure.

In the present disclosure, the first component is made of a first plastic material of electroplating grade, and the second component is made of a second plastic material of non-electroplating grade, so that the metal electroplating layer can be directly covered on part of the protrusions of the first component exposed from the second component to form electrical connection pins.

The earphone connector according to the present disclosure is formed by combining only the first component and the second component into an integral structure, and the metal plating layer is used to cover the portion of the first component exposed from the second component, so that an electrical connection structure can be directly formed on the first component, which is convenient for electrical connection with the earphone charging case to realize charging of the earphone. Thus, the overall structure is simple and the production efficiency can be greatly improved.

According to the present disclosure, the inner side of the first component is provided with a blocking wall structure, which is intended to control the flow behavior of the second plastic material in molding the earphone connector by a double-color injection molding machine, so as to guide the second plastic material to flow along a predetermined path.

In the present disclosure, if no blocking wall structure is provided, the second plastic material will flow along other paths, and will be mixed with part of the first plastic material to form a different color, and the different color will be produced on an outer surface of the second component, and the different color part will absorb the metal plating material, that is, excess plating will occur, thereby affecting the electrical connection effect between the earphone connector and the earphone charging case. Due to the guiding effect of the blocking wall structure provided in the present disclosure, the producing of different color can be greatly reduced, and the location at which different color may be produced can be changed, so that a trace amount of different color is formed on an inner surface of the second component, the different color produced is greatly reduced, and the ability to absorb metal electroplating materials is no longer available, so that the problem of excess plating will not occur, and the effect of electrical connection between the earphone connector and the earphone charging case is ensured.

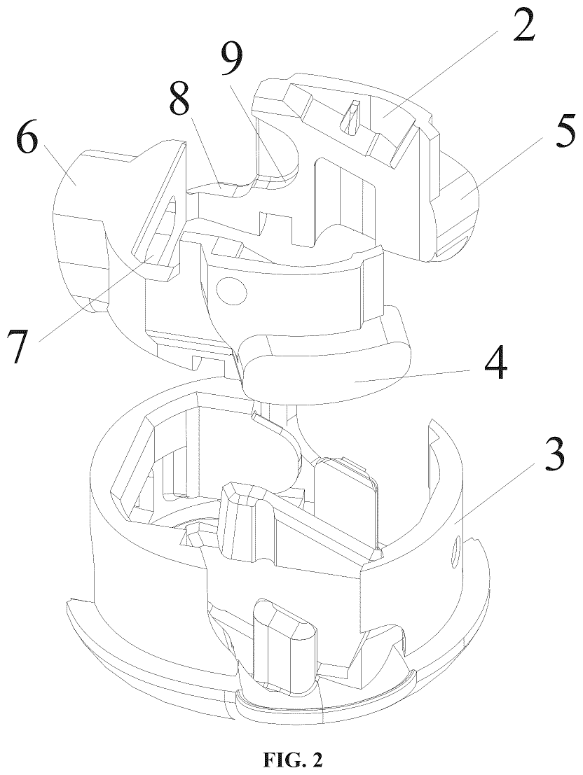

In any embodiment of the present disclosure, FIG. 2 is a schematic diagram of the first component and the second component in the earphone connector. The portion of the first component 2 exposed from the second component 3 has a first protrusion 4, a second protrusion 5 and a third protrusion 6 protruding from a surface of the second component 3. The first protrusion 4 is a ground pin, and the second protrusion 5 is a power pin. The third protrusion 6 has a through hole 7 that penetrates inner and outer surfaces of the first component 2, and the third protrusion 6 is electrically connected to the first protrusion 4.

In the present disclosure, other structures inside the earphone connector are not specifically limited, corresponding space is also leaved for other structures in the earphone connector. The configurations and positions of other structures can be flexibly changed, and the person skilled in the art may just make reasonable arrangements according to practical requirements.

Therefore, in molding the first component, the first shot mold is used to directly form the first component having the first protrusion, the second protrusion and the third protrusion, with the third protrusion being provided with a through hole, which serve as the ground pin, the power pin and the microphone hole respectively, without the need to use other components to form the above-mentioned functional structures, this further makes the overall structure of the earphone connector simpler and easier to form, and further improves the production efficiency. In addition, by electrically connecting the microphone hole with the ground pin, the reference potential of the audio signal is ensured to be stable, so that the microphone can correctly transmit sound signals.

In any embodiment of the present disclosure, there is a beam structure 8 between the third protrusion 6 and the second protrusion 5, and the blocking wall structure 9 is located on one side of the beam structure 8 and connected to the beam structure 8.

In the present disclosure, the material, size and specific configuration of the blocking wall structure are not specifically limited. The role of the blocking wall structure in the present disclosure is to control the flow behavior of the second plastic material to prevent the plastic material from directly flowing over the beam structure. Therefore, it can be understood that all other materials, sizes and specific configurations of the blocking wall structure that can achieve such functions can be used in the present disclosure, and the person skilled in the art can make adaptive adjustments according to practical requirements.

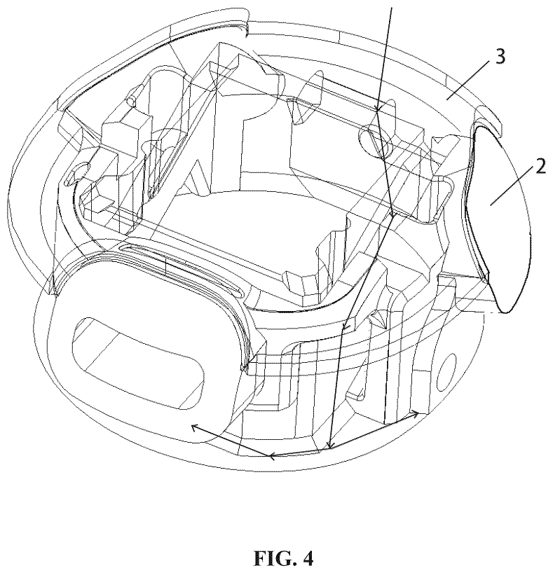

The blocking wall structure is formed on one side of the beam structure and in connection with the beam structure, so that in forming the second component, the second plastic material can flow in the direction guided by the blocking wall structure (the schematic diagram of flow is as shown in FIG. 4), and will not directly flow over the beam structure, such that the second plastic material is not divided into two streams until being on the inner side of the bottom of the first component and then the two streams are merged on the inner surface of the second component, and it will not occur that the second plastic material is divided into two streams at the top of the first component and the two streams are merged on the outer surface of the second component. Then the second plastic material will fill the cavity of the second injection mold.

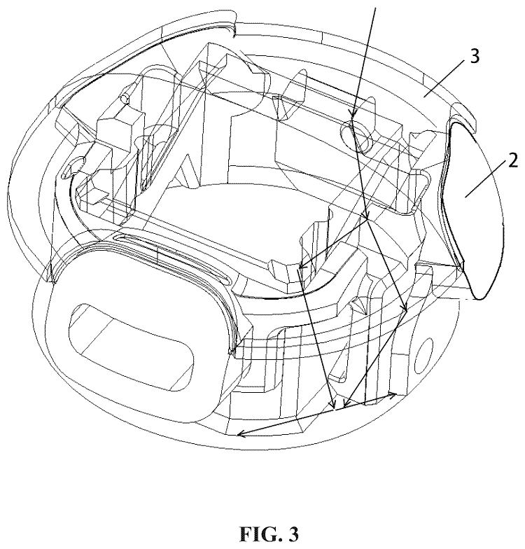

In the present disclosure, if the blocking wall structure is not provided, but the beam structure is passed directly, the second plastic material will produce a different color with the first component when flowing over the beam structure, and the second plastic material will be divided into two streams by the beam structure, and at the filling end of the second component, the two streams of plastic material will merge (the flow schematic diagram is as shown in FIG. 3), producing more different color, and the different color will be formed on the outer surface of the second component, causing excess plating. Therefore, the blocking wall structure and its positional relationship with the beam structure provided in the present disclosure solve the problem of excess plating.

### Preparation Method

A second aspect of the embodiment of the present disclosure is to provide a preparation method of an earphone connector, which can prepare the earphone connector of the first aspect of the embodiment of the present disclosure.

The preparation method includes steps as follows.
(1) In first-shot injection molding, a first plastic material of electroplating grade is injected into a first shot mold of a double-color injection molding machine, and after solidification, a first component is obtained.
(2) In second-shot injection molding, a second plastic material of non-electroplating grade is injected into a second shot mold of the double-color injection molding machine at the molding position of the first component, and the second plastic material is combined with the first component along an outer side of the blocking wall structure in a predetermined flow direction, and after solidification, a second component is obtained.

In the present disclosure, the double-color injection molding machine is used to mold the first component and the second component, and the overall operation process has no difference from the standard double-shot injection molding process, which is not specifically limited here, and the person skilled in the art can make reasonable settings according to practical requirements.

In the preparation method according to the present disclosure, a conventional double-color injection molding machine in the prior art can be used, and the double-color injection molding machine is used to prepare the first component and the second component. The first-shot injection molding and the second-shot injection molding share the same common mold parts, and there is no need to take the first-shot product out of the mold and implant it into the second-shot mold, thereby achieving high-precision and high-efficiency injection molding.

In the present disclosure, “standard double-shot injection molding process” means that the temperature of the second shot material is about 60 degree Celsius lower than that of the first shot material, which is conducive to the control of the injection molding process and ensures that the second shot material will not melt part of the surface of the first shot material when flowing by the first shot material in the second shot molding.

In any embodiment of the present disclosure, the melting temperature of the first plastic material ranges from 250 degree Celsius to 280 degree Celsius, for example, it can be 252 degree Celsius, 255 degree Celsius, 256 degree Celsius, 258 degree Celsius, 260 degree Celsius, 262 degree Celsius, 265 degree Celsius, 266 degree Celsius, 268 degree Celsius, 270 degree Celsius, 272 degree Celsius, 275 degree Celsius, 276 degree Celsius or 278 degree Celsius, etc., but it is not limited to the listed numerical values, and other unlisted numerical values within the numerical range are also applicable.

In some embodiments, the first plastic material can be a mixed material of acrylonitrile-butadiene-styrene copolymer (ABS) and polycarbonate material (PC). In addition, most of the commercially available PC materials are of non-electroplating grade, and their mechanical strength is relatively high; and the commercially available ABS materials are of electroplating grade, and their electroplating performance is good and corrosion resistance is strong, but their strength is relatively low. Therefore, by combining ABS with PC, the mechanical strength of the material is enhanced while the electroplating performance and corrosion resistance are ensured.

In the present disclosure, the selection of the first plastic material is not specifically limited, and the first plastic material can be obtained from the market, as long as the melting temperature of the selected material is within the range from 250 degree Celsius to 280 degree Celsius, so the first plastic material can be either a single material or a mixed material.

In any embodiment of the present disclosure, the melting temperature of the second plastic material ranges from 295 degree Celsius to 315 degree Celsius, for example, it can be 297 degree Celsius, 299 degree Celsius, 300 degree Celsius, 302 degree Celsius, 305 degree Celsius, 306 degree Celsius, 308 degree Celsius, 310 degree Celsius, 312 degree Celsius or 314 degree Celsius, etc., but it is not limited to the listed numerical values, and other numerical values not listed in the numerical range are also applicable.

In some embodiments, the second plastic material can be a polycarbonate material.

In the present disclosure, the selection of the second plastic material is not specifically limited, and the second plastic material can be obtained from the market as long as the melting temperature of the selected material is within the range from 295 degree Celsius to 315 degree Celsius. Therefore, the second plastic material can be either a single material or a mixed material.

In the present disclosure, if the earphone connector is prepared according to the standard double-shot injection molding process, that is, the second component is first formed by using the second injection molding material with a high melting temperature, and then the first component is formed by using the first injection molding material with a low melting temperature to be combined with the second component, when the combination is performed based on the structures of the first component and the second component, ruptures may occur between the two components due to stress, and the first component cannot be combined with the second component.

Aiming at injection molding of the earphone connector, through adjustment, the second plastic material with a melting temperature higher than that of the first plastic material is taken as the second shot material in the present disclosure. Compared with the standard double-shot injection molding process, the present disclosure takes the opposite approach. In addition, a blocking wall structure is formed on the inner side of the first component in molding the first component, therefore, even if the temperature of the second plastic material is higher than that of the first plastic material, the blocking wall structure changes the flow direction of the second plastic material, and it will not occur that the second plastic material is divided into two streams and then the two streams are merged on the outer surface of the second component. Even if part of the surface of the first component is melted and mixed into the second plastic material due to the interaction between high and low temperatures, the different color producing can be greatly reduced and the location where the different color is produced can be changed due to the role of the blocking wall structure, thereby solving the problem of excess plating.

In any embodiment of the present disclosure, in step (2), the injection speed of the second plastic material in the second shot mold ranges from 90 mm/s to 110 mm/s, for example, it can be 92 mm/s, 95 mm/s, 96 mm/s, 98 mm/s, 100 mm/s, 102 mm/s, 105 mm/s, 106 mm/s or 108 mm/s, but it is not limited to the listed numerical values, and other numerical values not listed within the numerical range are also applicable. By controlling the injection speed of the second plastic material in the second shot mold within the range from 90 mm/s to 110 mm/s to ensure that the second plastic material quickly passes along the outer side of the blocking wall structure during the injection molding process, it is conducive to reducing the melting of the surface of the first component and further avoiding the problem of different color producing in the second injection molding.

In the present disclosure, if the injection speed of the second injection is lower than 90 mm/s, the different color producing will increase; and if the injection speed of the second injection is higher than 110 mm/s, the second plastic material cannot fill the cavity of the second shot mold, which may adversely affect the molding effect of the second component.

In addition, except for the melting temperature of the first plastic material, the melting temperature of the second plastic material and the second injection speed of the second plastic material that are required to be controlled, the values of other parameters are not limited as long as they are within reasonable ranges, the first component and the second component may just be molded, and the person skilled in the art may just make reasonable settings according to practical requirements.

In any embodiment of the present disclosure, the preparation method further includes step (3) in which the portion of the first component exposed from the second component is electroplated. By forming electrical connection pins on part of the protrusions of the first component exposed from the second component by electroplating, in combination with the double-shot injection molding method, the preparation process of the earphone connector is greatly simplified.

In the present disclosure, the relevant parameters of the electroplating process are not specifically limited. The role of the electroplating process in the present disclosure is to provide good conductivity for the treated part to be used as an electrode and enhance corrosion resistance and wear resistance; therefore, the person skilled in the art can adaptively adjust the relevant parameters of the electroplating process according to practical requirements.

In any embodiment of the present disclosure, before the electroplating process, the portion of the first component exposed from the second component is roughened. The adhesion between the first component and the first metal layer can be increased by the roughening process, thereby ensuring the electroplating effect.

In the present disclosure, the specific steps and related parameters of the roughening process are not specifically limited. The role of the roughening process in the present disclosure is to increase the adhesion between the first plastic material and the first metal layer; therefore, the person skilled in the art can adaptively adjust the specific steps and related parameters of the roughening process according to the practical situation.

In any embodiment of the present disclosure, the electroplating process includes: electroplating a first metal layer on the portion of the first component exposed from the second component, and electroplating a second metal layer on the first metal layer. The two metal layers are used as the electroplated metal layer, thereby further improving the stability of electrical connection.

In some embodiments, the material of the first metal layer can be copper, and the material of the second metal layer can be palladium, gold, rhodium or ruthenium, etc.

In this application, the materials of the first metal layer and the second metal layer are not specifically limited, and the person skilled in the art can select the corresponding metal layer materials according to practical requirements.

### Embodiments

In the following embodiments, the contents disclosed in this application are described in more detail. The embodiments are only used for illustrative purposes, because it is obvious to the person skilled in the art to make various modifications and changes within the scope of the contents disclosed in this application. Unless otherwise specified, all raw materials and instruments used in the embodiments are commercially available.

### Embodiment One

An earphone connector and a preparation method thereof are provided according to this embodiment. The earphone connector includes a first component and a second component that are combined with each other. The first component is made of a first plastic material of electroplating grade, the second component is made of a second plastic material of non-electroplating grade, a portion of the first component exposed from the second component is covered with a metal electroplating layer, and an inner side of the first component is provided with a blocking wall structure.

The portion of the first component exposed from the second component has a first protrusion, a second protrusion and a third protrusion protruding from a surface of the second component. The first protrusion is a ground pin, and the second protrusion is a power pin. The third protrusion has a through hole that penetrates inner and outer surfaces of the first component, and the third protrusion is electrically connected to the first protrusion; and a beam structure is provided between the third protrusion and the second protrusion, and the blocking wall structure is located on one side of the beam structure and connected to the beam structure.

The preparation method includes the following steps:
(1) In a first-shot injection molding, a first plastic material of electroplating grade is injected into a first shot mold of a double-color injection molding machine, and after solidification, a first component is obtained.

Specifically, the first plastic material is a mixed material of PC with a melting temperature of 260 degree Celsius and ABS of electroplating grade;
(2) In a second-shot injection molding, a second plastic material of non-electroplating grade is injected into the second shot mold of the double-color injection molding machine at the molding position of the first component, and the second plastic material is combined with the first component along an outer side of the blocking wall structure in a predetermined flow direction, and after solidification, a second component is obtained.

Specifically, the second plastic material is PC of non-electroplating grade with a melting temperature of 300 degree Celsius; the injection speed of the second plastic material in the second shot mold is 100 mm/s;
(3) In an electroplating process: roughening process and electroplating process are performed on the portion of the first component exposed from the second component in sequence to obtain the earphone connector;

Specifically, in the electroplating process: the portion of the first component exposed from the second component is electroplated with a copper layer, and then the surface of the copper layer is electroplated with a gold layer.

The earphone connector produced in this embodiment does not have the problem of excess plating, and can be electrically connected to the earphone charging case to realize charging of the earphone. The overall structure is simple, the molding is simple and the production efficiency is high.

The applicant declares that the above is only embodiments of the present disclosure, but the protection scope of the present disclosure is not limited thereto. It is to be understood that any variations or substitutions easily conceivable by the person skilled in the art within the technical scope disclosed by the present disclosure fall within the protection scope and disclosure scope of the present disclosure.

What is claimed is:

1. An earphone connector, comprising a first component and a second component that are combined with each other, wherein the first component is made of a first plastic material of electroplating grade, the second component is made of a second plastic material of non-electroplating grade, a portion of the first component exposed from the second component is covered with a metal electroplating layer, and an inner side of the first component is provided with a blocking wall structure.

2. The earphone connector according to claim 1, wherein the portion of the first component exposed from the second component has a first protrusion, a second protrusion and a third protrusion protruding from a surface of the second component, the first protrusion is a ground pin, and the second protrusion is a power pin; and the third protrusion has a through hole that penetrates inner and outer surfaces of the first component, and the third protrusion is electrically connected to the first protrusion.

3. The earphone connector according to claim 2, wherein a beam structure is formed between the third protrusion and the second protrusion, and the blocking wall structure is located on one side of the beam structure and connected to the beam structure.

4. A preparing method of an earphone connector, comprising steps:
(1) first-shot injection molding: injecting a first plastic material of electroplating grade into a first shot mold of a double-color injection molding machine, and after solidification, obtaining a first component;
(2) second-shot injection molding: injecting a second plastic material of non-electroplating grade into a second shot mold of the double-color injection molding machine at a molding position of the first component, the second plastic material being combined with the first component along an outer side of the blocking wall structure in a predetermined flow direction, and after solidification, obtaining a second component;
wherein the earphone connector comprises a first component and a second component that are combined with each other, wherein the first component is made of a first plastic material of electroplating grade, the second component is made of a second plastic material of non-electroplating grade, a portion of the first component exposed from the second component is covered with a metal electroplating layer, and an inner side of the first component is provided with a blocking wall structure.

5. The preparing method according to claim 4, wherein a melting temperature of the first plastic material ranges from 250 degree Celsius to 280 degree Celsius.

6. The preparing method according to claim 4, wherein a melting temperature of the second plastic material ranges from 295 degree Celsius to 315 degree Celsius.

7. The preparing method according to claim 4, wherein in step (2), an injection speed of the second plastic material in the second shot mold ranges from 90 mm/s to 110 mm/s.

8. The preparation method according to claim 4, further comprising step (3): electroplating a portion of the first component exposed from the second component.

9. The preparation method according to claim 8, wherein before the electroplating, the portion of the first component exposed from the second component is roughened.

10. The preparation method according to claim 8, wherein the electroplating comprises:
electroplating a first metal layer on the portion of the first component exposed from the second component, and electroplating a second metal layer on the first metal layer.

11. The preparation method according to claim 5, further comprising step (3): electroplating a portion of the first component exposed from the second component.

12. The preparation method according to claim 11, wherein before the electroplating, the portion of the first component exposed from the second component is roughened.

13. The preparation method according to claim 11, wherein the electroplating comprises: electroplating a first metal layer on the portion of the first component exposed from the second component, and electroplating a second metal layer on the first metal layer.

14. The preparation method according to claim 6, further comprising step (3): electroplating a portion of the first component exposed from the second component.

15. The preparation method according to claim 14, wherein before the electroplating, the portion of the first component exposed from the second component is roughened.

16. The preparation method according to claim 14, wherein the electroplating comprises: electroplating a first metal layer on the portion of the first component exposed from the second component, and electroplating a second metal layer on the first metal layer.

17. The preparation method according to claim 7, further comprising step (3): electroplating a portion of the first component exposed from the second component.

18. The preparation method according to claim 17, wherein before the electroplating, the portion of the first component exposed from the second component is roughened.

19. The preparation method according to claim 17, wherein the electroplating comprises: electroplating a first metal layer on the portion of the first component exposed from the second component, and electroplating a second metal layer on the first metal layer.

20. The preparing method according to claim 4, wherein the portion of the first component exposed from the second component has a first protrusion, a second protrusion and a third protrusion protruding from a surface of the second component, the first protrusion is a ground pin, and the second protrusion is a power pin; and the third protrusion has a through hole that penetrates inner and outer surfaces of the first component, and the third protrusion is electrically connected to the first protrusion;
wherein a beam structure is formed between the third protrusion and the second protrusion, and the blocking wall structure is located on one side of the beam structure and connected to the beam structure.
